(19) United States
(12) Patent Application Publication
(10) Pub. No.: US 2015/0378453 A1
(43) Pub. Date: Dec. 31, 2015

(54) ACTIVE CAPACITIVE STYLUS AND SENSING METHOD THEREOF

(71) Applicant: KYE SYSTEMS CORP., New Taipei (TW)

(72) Inventors: He-Sung WU, New Taipei (TW); Chih-Min LIU, New Taipei (TW); Chih-Wen WANG, New Taipei (TW)

(21) Appl. No.: 14/749,736

(22) Filed: Jun. 25, 2015

(30) Foreign Application Priority Data
Jun. 25, 2014 (TW) 103121972

(51) Int. Cl. G06F 3/038; G06F 3/0354

(52) U.S. Cl. CPC G06F 3/0383; G06F 3/03545

(57) ABSTRACT

An active capacitive stylus and a sensing method thereof are provided. The active capacitive stylus includes a pen tip, a frequency adjuster, a frequency generating module, and a control module. The pen tip includes a contact component for moving in response to a pressing force. The frequency adjuster simultaneously moves with the contact component. The frequency generating module generates an induction frequency according to an induction distance between the frequency adjuster and the frequency generating module. The control module is electrically connected to the frequency generating module and calculates a pressure value according to the induction frequency.

### CROSS-REFERENCE TO RELATED APPLICATIONS

This non-provisional application claims priority under 35 U.S.C. §119(a) on Patent Application No(s). 103121972 filed in Taiwan, R.O.C. on Jun. 25, 2014, the entire contents of which are hereby incorporated by reference.

### TECHNICAL FIELD

The disclosure relates to an active capacitive stylus and a sensing method thereof, more particularly to an active capacitive stylus capable of sensing a pressing force by sensing the change of a resonant frequency output by an oscillation circuit, and to a sensing method thereof.

### BACKGROUND

General capacitive stylus pens are usually disposed with a pen tip made of electric-conductive rubber or EMI gasket at the front end of its metal pen tube. Such a pen tip has a good wear resistance, a high response speed, achieves more accurate touch control than fingers and may be unable to scrape an external device. However, the external device has a lower sensibility in relation to the capacitive stylus pen so that it is difficult for the capacitive stylus pen to write small font-size words and even form desired writings on the external device based on the writing force.

Moreover, active capacitive styluses nowadays need a pressure sensor to sense a pressing force applied to the pen tip. For example, a capacitive pressure sensor as a pressure sensor converts a pressing force into an electrical signal by its capacitive sensing element. However, the disposition of pressure sensors will increase the manufacture costs and power consumption of an active capacitive stylus.

### SUMMARY

According to one or more embodiments, the disclosure provides an active capacitive stylus. In an embodiment, the active capacitive stylus includes a pen tip, a frequency adjuster, a frequency generating module, and a control module. When an external pressing force is applied to the pen tip, the pen tip simultaneously moves with the frequency adjuster. The frequency generating module, according to a location of the frequency adjuster, generates an induction signal having an induction frequency. After calculating a pressure value according to the induction signal, the control module encodes the pressure value into a digital control signal and sends the digital control signal to the pen tip.

### BRIEF DESCRIPTION OF THE DRAWINGS

The present invention will become more fully understood from the detailed description given hereinbelow and the accompanying drawings which are given by way of illustration only, thus are not limitative of the present invention and wherein:

FIG. 1 is a block diagram of an active capacitive stylus according to an embodiment of the disclosure;

FIG. 2 is a schematic view of a frequency adjuster in the active capacitive stylus according to an embodiment of the disclosure;

FIG. 3 is a circuit diagram of a frequency generating module in the active capacitive stylus according to an embodiment of the disclosure;

FIG. 4 is a circuit diagram of a frequency generating module in the active capacitive stylus according to another embodiment of the disclosure;

FIG. 5 is a block diagram of an active capacitive stylus according to another embodiment of the disclosure;

FIG. 6 is a block diagram of an active capacitive stylus according to another embodiment of the disclosure; and

FIG. 7 is a flow chart of a sensing method of an active capacitive stylus according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

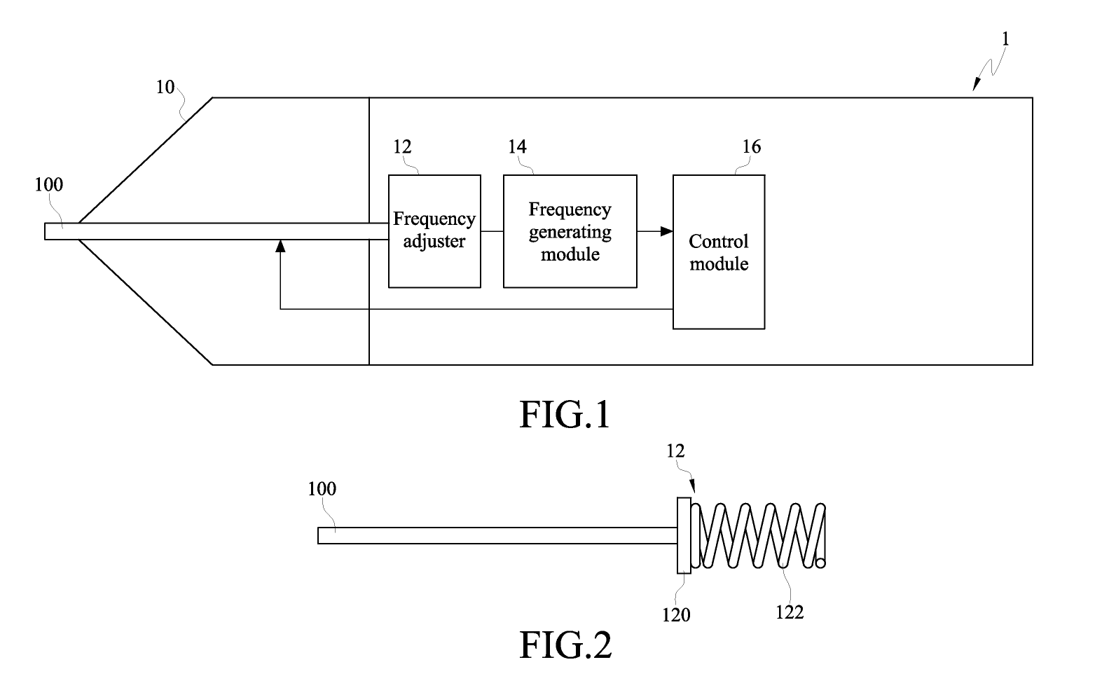

Please refer to FIG. 1, which is a block diagram of an active capacitive stylus 1 according to an embodiment of the disclosure. The active capacitive stylus 1 includes a pen tip 10, a frequency adjuster 12, a frequency generating module 14, and a control module 16. The pen tip 10 includes a contact component 100. The frequency adjuster 12 contacts or connects to the contact component 100. The frequency adjuster 12 is movable or extendable. When an external pressing force is applied to the contact component 100, the contact component 100 simultaneously moves with the frequency adjuster 12 or presses the frequency adjuster 12. The control module 16 is coupled to the frequency generating module 14 and the contact component 100. In an example, the frequency generating module 14 is carried out by a variety of oscillation circuit and is coupled to the frequency adjuster 12.

The pen tip 10 is configured in the front part of the active capacitive stylus 1. The contact component 100 can receive a pressing force provided outside. For instance, the contact component 100 is a metallic conductor for transmitting signals such as a digital control signal. Also, the contact component 100 can receive signals from the control module 16 and then send them to a sensing region of another external device. In an example, the control module 16 sends a digital control signal to the contact component 100, and then the contact component 100 sends this digital control signal to a sensing region of an external device. For example, the external device is a tablet computer or any device with a touch panel. Therefore, the external device can perform a touch control function by the active capacitive stylus 1. In an embodiment, the control module 16 in the active capacitive stylus 1 can actively send out a positioning signal.

Please refer to FIG. 2, which is a schematic view of a frequency adjuster 12 in the active capacitive stylus according to an embodiment of the disclosure. The frequency adjuster 12 includes a driving component 120 and an elastic component 122. The frequency adjuster 12 connects to or contacts the contact component 100 through the driving component 120. When an external pressing force is applied to the contact component 100, the contact component 100 simultaneously moves with the driving component 120 and the location of the driving component 120 is changed.

In an exemplary embodiment, when the contact component 100 touches a tablet computer, the contact component 100 is applied with a force, i.e. an external pressing force to move toward the inside of the active capacitive stylus 1 and simultaneously pushes the driving component 120 to move toward the inside of the active capacitive stylus 1. Moreover, because of the existence of the elastic component 122, the pushing force applied to the driving component 120 causes a restoring force that is opposite the pushing force. The elastic component 122 affects the relationship between the level of the external pressing force and the changing level of the location of the driving component 120. For example, the driving component 120 is, but not limited to, made of magnetic-conductive material or metal material. For example, the elastic component 122 is, but not limited to, a spring, a rubber spring or a rubber. The materials of the driving component 120 and the elastic component 122 can be selected according to actual application requirements.

The frequency generating module 14 at least includes a first inductor L1 and a first capacitor C1. The first inductor L1 has a first inductance, and the first capacitor C1 has a first capacitance. In an example, the first inductor L1 is a variable inductor (referred to as the variable inductor) having the first inductance that is adjustable while the first capacitor C1 is an invariable capacitor having the first capacitance that is not adjustable. In another example, the first inductor L1 is an invariable inductor having the first inductance that is not adjustable while the first capacitor C1 is a variable capacitor (referred to as the variable capacitor) having the first capacitance that is adjustable.

In an example, the driving component 120 in the frequency adjuster 12 is made of iron, zinc or other materials for adjusting the equivalent inductance when the first inductor L1 is a variable inductor. In an example, the driving component 120 is made of metal or other materials for adjusting the equivalent capacitance when the first capacitor C1 is a variable capacitor. Either the use of the variable inductor and invariable capacitor or the use of the invariable inductor and variable capacitor can be selected according to actual application requirements.

The driving component 120 has a distance with the variable inductor in an example or with the variable capacitor in another example. When the contact component 100 is not applied with any external pressing force, the contact component 100 and the driving component 120 do not move together. Herein, the distance between the driving component 120 and either the variable inductor in an example or the variable capacitor in another example is an initial induction distance. Therefore, the frequency generating module 14 has a resonant frequency as a basis resonant frequency under the principle of oscillation circuit. Data related to this basis resonant frequency is sent to the control module 16.

When the contact component 100 is applied with an external pressing force, the contact component 100 simultaneously moves with the driving component 120 and the location of the driving component 120 is changed. Herein, the distance between the driving component 120 and either the variable inductor in an example or the variable capacitor in another example is a pressed induction distance. Moreover, when the location of the driving component 120 is changed in response to the move of the contact component 100, the variable inductor senses a new second inductance in response to the move of the driving component 120 in an example or the variable capacitor senses a new second capacitance in response to the move of the driving component 120 in another example. Therefore, under the principle of oscillation circuit, the frequency generating module 14 has another resonant frequency referred to as a pressed resonant frequency. Data related to the pressed resonant frequency is sent to the control module 16.

Accordingly, the pressed induction distance and the pressed resonant frequency change in response to how much the external pressing force applied to the contact component 100 is. In an embodiment, the external pressing force and the pressed resonant frequency have a function relation therebetween. The relationship between the resonant frequency and the external pressing force is based on the elasticity and rigidity of the elastic component 122 and the move of the driving component 120. In an example, assume that the elastic component 122 has an elasticity index of 5 g/mm. When an external pressing force of 3 g is applied to the contact component 100, the elastic component 122 is moved by 0.6 mm. The capacitor coupling effect affects the equivalent capacitance of the variable capacitor in an example, and the inductor coupling effect affects the equivalent inductance of the variable inductor in another example. Moving the elastic component 122 by 0.6 mm causes that either the equivalent capacitance of the variable capacitor in an example or the equivalent inductance of the variable inductor in another example changes 12%, thereby changing the output frequency of the frequency generating module 14 (e.g. the oscillation circuit).

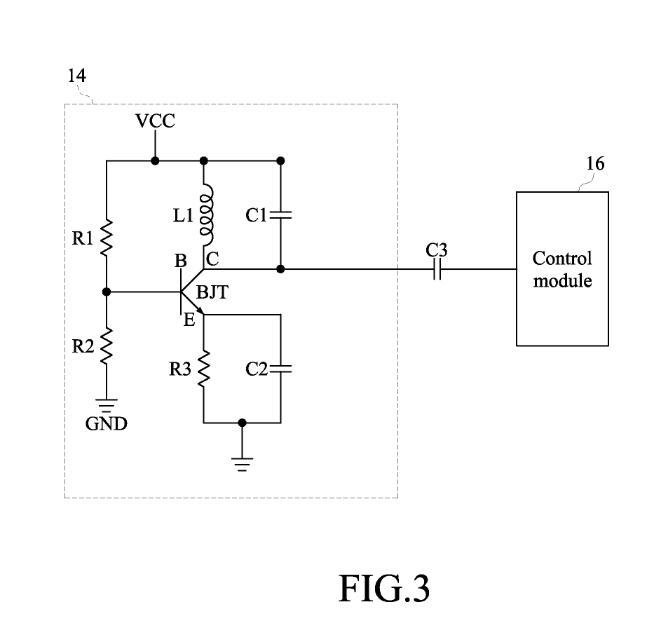

The inner components and their connections of the frequency generating module 14 are illustrated in details by referring to FIG. 3, which is a circuit diagram of a frequency generating module 14 in the active capacitive stylus according to an embodiment of the disclosure. The frequency generating module 14 includes a first resistor R1 and a second resistor R2 connected in series. One end of the first resistor R1 is coupled to a direct-current (DC) power terminal VCC, and one end of the second resistor R2 is grounded. The node joining the first resistor R1 and the second resistor R2 together is coupled to the base B of a bipolar transistor BJT. The collector C of the bipolar transistor BJT is coupled to one end of the first inductor L1 and one end of the first capacitor C1, and the DC power terminal VCC is coupled to the other end of the first inductor L1 and the other end of the first capacitor C1. The collector C of the bipolar transistor BJT is coupled to one end of a third capacitor C3, and the control module 16 is coupled to the other end of the third capacitor C3. The emitter E of the bipolar transistor BJT is coupled to one end of a third resistor R3, and the other end of the third resistor R3 is grounded. The third resistor R3 and a second capacitor C2 are connected in parallel.

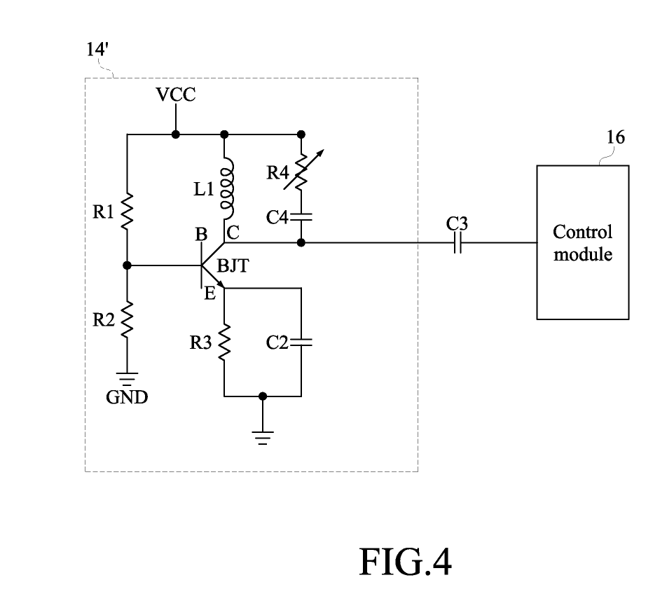

Another embodiment of the frequency generating module is illustrated in FIG. 4, which is a circuit diagram of the frequency generating module 14′. The frequency generating module 14′ in FIG. 4 is similar to the frequency generating module 14 in FIG. 3, but either the first variable inductor or the first variable capacitor in FIG. 3 is replaced by a variable resistor R4 and a capacitor C4 connected in series in FIG. 4. In an embodiment, the resistance of the variable resistor R4 changes in response to the move of the driving component 120. Therefore, the frequency adjuster generates another sensing signal in response to the change of the equivalent resistor of the variable resistor R4. The frequency generating module 14′ in FIG. 4 is an oscillation circuit designed according to actual application requirements.

Please refer to FIG. 1, the control module 16 in an embodiment calculates a pressure value of the external pressing force applied to the contact component 100 according to an induction frequency of the frequency generating module 14, which is associated with the basis resonant frequency and the pressed resonant frequency. Then, the control module 16 encodes the pressure value into a digital control signal. Calculating the pressure value according to the induction frequency can be carried out by various ways. For example, the control module 16 stores a frequency calculation program to calculate the pressure value by referring to the induction frequency. The frequency calculation program supports one or more mathematical activities such as formula calculation, look-up table or other calculation methods for calculating a pressure value in relation to a frequency. In an embodiment, the control module 16 calculates the induction frequency by the difference between the basis resonant frequency and the pressed resonant frequency. In another embodiment, the induction frequency is associated with the pressed resonant frequency, where the pressed resonant frequency is considered as the induction frequency as the basis resonant frequency is a default value. The person skilled in the art can set the above induction frequency and choose a suitable calculation method according actual application requirements.

When the control module 16 encodes the pressure value by two different symbols “0” and “1” having different frequencies in the binary numeral system under a certain data format, the digital control signal is obtained. In an embodiment, for the digital control signal, the first bit corresponds to a first bit value, and the second bit corresponds to a second bit value. For example, the control module 16 encodes the pressure value by the binary numeral system to produce an 8-bit digital control signal such as 10100101. The person skilled in the art can choose a suitable calculation method and encoding method according to actual application requirements.

In another embodiment, the control module 16 encodes the pressure value and extra information, such as the status value of function key or information about the coordinate, the model number, the firmware version or the battery capacity, or any combination thereof, to produce the digital control signal. The status value of function key indicates the selection of a function key of the active capacitive stylus 1.

In another embodiment, the digital control signal includes a first frequency and a second frequency and is sent from the contact component 100 to an external device, such as a tablet computer including a transmission module to receiving the digital control signal. The contact component 100 herein is made of metal and capable of transmitting signal. Therefore, the external device can fulfill the result of sensing the pressing force. In an example, assume that the digital control signal is an 8-bit binary signal of 10100101. “0” of the 8-bit binary signal indicates a first frequency, and “1” of the 8-bit binary signal indicates a second frequency. The front 4-bit stream “1010” of the 8-bit binary signal indicates the level of the pressing force applied to the contact component 100, and the last 4-bit stream “0101” of the 8-bit binary signal indicates a function corresponding to a function key. Therefore, the external device can use information indicated in the digital control signal. The person skilled in the art can define the data status specified by a bit value according to actual application requirements.

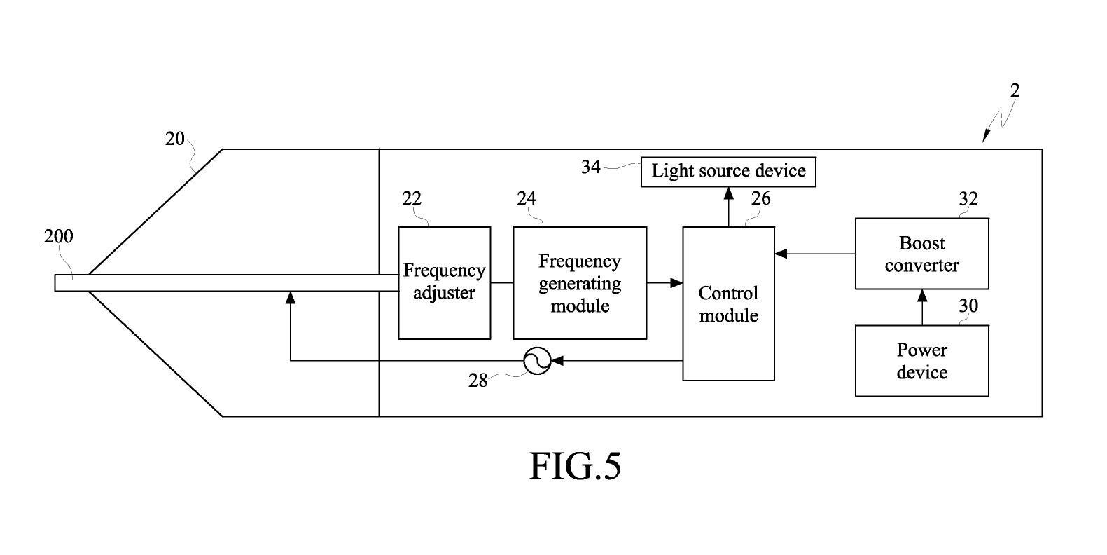

Please refer to FIG. 5, which is a block diagram of an active capacitive stylus 2 according to another embodiment of the disclosure. In addition to the pen tip 20, the frequency adjuster 22, the frequency generating module 24, and the control module 26 in the active capacitive stylus 1, the active capacitive stylus 2 also includes an amplifier 28, a power device 30, boost converter 32, a light source device 34 or a combination thereof to carry out more functions.

Similar to the active capacitive stylus 1 in FIG. 1, the pen tip 20 includes the contact component 200 that simultaneously moves with the frequency adjuster 22, the frequency generating module 24 provides an equivalent inductance or capacitance according to the location of the driving component in the frequency adjuster 22 so as to produce an induction frequency, and the control module 26 calculates a pressure value according to the induction frequency received from the frequency generating module 24 and produces a digital control signal according to the pressure value or according to the pressure value and one or more extra information.

However, the differences between the active capacitive stylus 1 in FIG. 1 and the active capacitive stylus 2 in FIG. 5 includes that the amplifier 28 is coupled to the control module 26 and the contact component 200. After the control module 26 sends the digital control signal to the amplifier 28, the amplifier 28 amplifies the digital control signal and then sends the amplified digital control signal to an external device through the contact component 200. Then, the external device recognizes this signal received from the contact component 200.

The boost converter 32 is coupled to the power device 30 and the control module 26, and the light source device 34 is coupled to the control module 26. The power device 30 supplies power to the active capacitive stylus 2 and is, for example but not limited to, a battery. The boost converter 32 converts the power provided by the power device 30 into the electricity for the control module 26. The light source device 34 receives signals from the control module 26 and controls the operation of the light source device 34. In an example, if the electricity provided by the power device 30 or the electricity amplified by the boost converter 32 is lower than the need of the control module 26, the control module 26 will send a signal to control the lighting of the light source device 34 for notifying users that the active capacitive stylus 2 is running out of power.

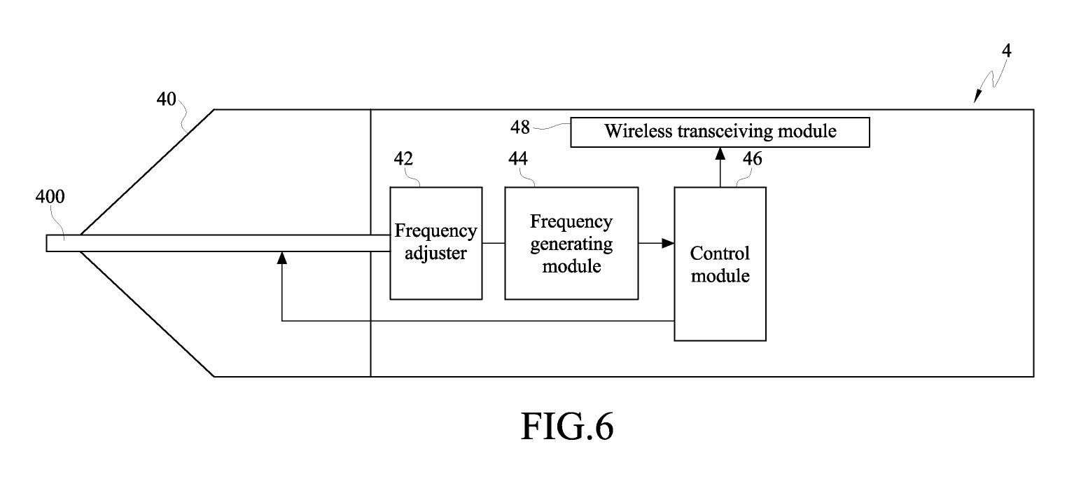

Please refer to FIG. 6, which is a block diagram of an active capacitive stylus according to another embodiment of the disclosure. The active capacitive stylus 4 includes a pen tip 40, a frequency adjuster 42, a frequency generating module 44, a control module 46, and a wireless transceiving module 48. Similar to the active capacitive stylus 1 in FIG. 1, the pen tip 40 includes a contact component 400 that simultaneously moves with the frequency adjuster 42; the frequency generating module 44 provides an equivalent inductance or capacitance according to the position of the driving component in the frequency adjuster 42 so as to produce an induction frequency; and the control module 46 produces a pressure value according to the induction frequency, and encodes the pressure value into a digital control signal. However, different from the active capacitive stylus 1 in FIG. 1, by the wireless transceiving module 48, the digital control signal is sent to an external device, such as a tablet computer including a wireless transmission module to receive the digital control signal.

In an embodiment, the control module 46 merely encodes the pressure value to produce the digital control signal. In another embodiment, the control module 46 encodes the pressure value and one or more extra information, such as information about the coordinate, the selection of function keys, the model number, the firmware version, or the battery capacity related to the active capacitive stylus 4, to produce the digital control signal such that the external device can use such extra information after receiving the digital control signal. In another embodiment, the control module 46 encodes the pressure value and one or more extra information, such as the information about the selection of function keys, the model number, the firmware version, or the battery capacity related to the active capacitive stylus 4, to produce the digital control signal and encodes the coordinate information to produce a positioning signal with a certain frequency. Then, the control module 46 sends the digital control signal to an external device through the wireless transceiving module 48 and outputs the positioning signal to an amplifier. After amplifying the positioning signal, the amplified positioning signal is sent to the contact component 400 and then is transferred to a sensing region of the external device from the contact component 400 so that the external device can verify the location of the active capacitive stylus 4.

In an example, the wireless transceiving module 48 is, but not limited to, a Bluetooth device, Wi-Fi device, or other devices for wireless signal transmission. In an example, the active capacitive stylus 4 can communicate with an external device in opposite directions by the bidirectional digital transmission technology and the operation of the wireless transceiving module 48 so that users can do operations such as function setting or firmware updating to the active capacitive stylus 4.

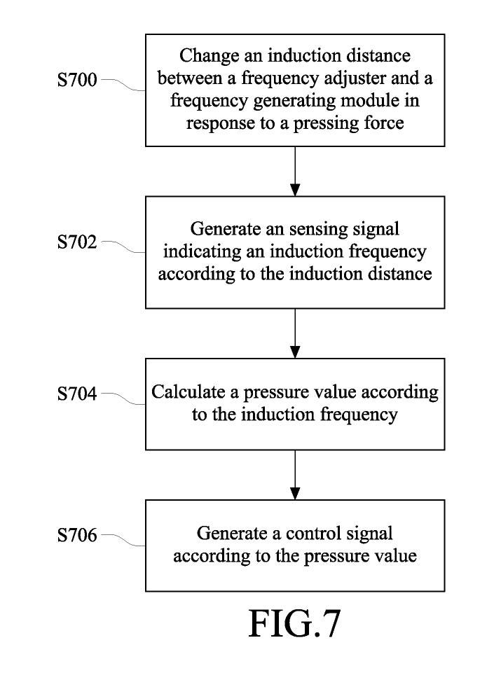

In view of the various foregoing embodiments of the active capacitive stylus, a sensing method of the active capacitive stylus is concisely summarized and illustrated as follows by referring FIG. 1 and FIG. 7, which is a flow chart of a sensing method of an active capacitive stylus according to an embodiment of the disclosure. In step S700, the contact component 100 is applied with an external pressing force so that the induction distance between the frequency adjuster 12 and the frequency generating module 14 is changed in response to the external pressing force. In step S702, the frequency generating module 14 produces a sensing signal in response to the induction distance, and a different sensing signal corresponds to a different induction frequency. In step S704, the control module 16 uses a look-up table or mathematical formula to obtain a pressure value according to the induction frequency. In step S706, the control module 16 encodes the pressure value to produce a digital control signal and sends the digital control signal to an external device. Alternately, the control module 16 encodes the pressure value and extra information, such as the information about the coordinate, the selection of function keys, the model number, the firmware version, the battery capacity, or a combination thereof, to produce a digital control signal. In an example, the digital control signal is sent to a sensing region of the external device by the contact component 100 so that the external device can use information indicated in the digital control signal.

In summary, the active capacitive stylus in the disclosure employs the above frequency generating module (e.g. an oscillation circuit) including a variable inductor or capacitor to provide an equivalent inductance or capacitance in response to the move of the driving component in the above frequency adjuster, thereby changing an induction frequency of the above frequency generating module. Also, the above control module is employed to calculate a pressure value according to the induction frequency, encode at least the pressure value into a digital control signal, and send the digital control signal to an external device including a touch panel. Since the active capacitive stylus in the disclosure operates without any pressure transducer or force sensor, the active capacitive stylus may sense a pressing force under lower power consumption and manufacture costs.

What is claimed is:

1. An active capacitive stylus, comprising:
a pen tip comprising a contact component for moving in response to a pressing force;
a frequency adjuster configured to simultaneously move with the contact component;
a frequency generating module configured to generate an induction frequency according to an induction distance between the frequency adjuster and the frequency generating module; and
a control module electrically connected to the frequency generating module and configured to calculate a pressure value according to the induction frequency.

2. The active capacitive stylus according to claim 1, wherein the frequency adjuster comprises a driving component and an elastic component, and the induction distance is a distance between the driving component and the frequency generating module.

3. The active capacitive stylus according to claim 2, wherein the driving component contacts the elastic component, and when being pressed, the contact component pushes the driving component and the induction distance is changed.

4. The active capacitive stylus according to claim 3, wherein the elastic component is configured to decide a relationship between the pressing force and the induction distance.

5. The active capacitive stylus according to claim 1, wherein the frequency generating module comprises a first variable inductor or a first variable capacitor, and the induction distance is a distance between the frequency adjuster and the first variable inductor or the first variable capacitor.

6. The active capacitive stylus according to claim 5, wherein the first variable inductor or the first variable capacitor has a second inductance or a second capacitance in response to a location of the frequency adjuster, and according to the second inductance or the second capacitance, the frequency generating module generates the induction frequency.

7. The active capacitive stylus according to claim 1, wherein the control module encodes the pressure value to produce a digital control signal.

8. The active capacitive stylus according to claim 7, wherein the control module encodes the pressure value and a status value of function key into the digital control signal.

9. The active capacitive stylus according to claim 7, further comprising: an amplifier electrically connected to the control module and the contact component and configured to amplify the digital control signal and send the amplified digital control signal to the contact component.

10. The active capacitive stylus according to claim 7, further comprising: a wireless transceiving module for receiving the digital control signal from the control module and then sending the digital control signal to an external device.

11. A sensing method of an active capacitive stylus, comprising:
changing an induction distance between a frequency adjuster and a frequency generating module in response to a pressing force;
generating an induction frequency according to the induction distance; and
calculating a pressure value according to the induction frequency.

12. The sensing method according to claim 11, wherein the pressure value is encoded into a digital control signal after the pressure value is calculated according to the induction frequency.

13. The sensing method according to claim 12, wherein the pressure value and a status value of function key are encoded into the digital control signal.

14. The sensing method according to claim 12, wherein the digital control signal is sent to an external device by a wireless transceiving module after the digital control signal is generated.
